(19) United States
(12) Patent Application Publication
(10) Pub. No.: US 2026/0135049 A1
(43) Pub. Date: May 14, 2026

(54) RUBBER DOME WITH ADVANCED CONDUCTION

(71) Applicant: INJECTION PRECISION RUBBER (SUZHOU) CO., LTD., SuZhou (CN)

(72) Inventors: Wei ZOU, Xuzhou (CN); Bohan LI, SuZhou (CN); Peiyun ZHANG, SuZhou (CN)

(21) Appl. No.: 18/548,246

(22) PCT Filed: Aug. 16, 2023
(86) PCT No.: PCT/CN2023/113249

§ 371 Date: Aug. 29, 2023

(30) Foreign Application Priority Data
Aug. 1, 2023 (CN) 202310959807.7

(51) Int. Cl. H01H 13/04; H01H 13/14; H01H 13/70

(52) U.S. Cl. CPC H01H 13/04; H01H 13/14; H01H 13/70

(57) ABSTRACT

The present disclosure discloses a rubber dome with advanced conduction which includes a support portion, an elastic connection portion, and a pressing portion connected in sequence, the pressing portion having a columnar triggering portion at an axially inner side thereof. An axial end of the triggering portion is spaced at an axial distance b from an axially lower surface of the support portion, and an axial upper surface of the support portion is spaced at a distance h from the axially lower surface of the support portion, and b<h. The pressing portion is axially opened with a bowl-shaped groove extending to the triggering portion. The rubber dome provided by the present disclosure avoids the over-sensitivity phenomenon conventionally caused by lowering the triggering force of the thin film circuit switch by adjusting the conduction distance to make the triggering portion closer to the thin film circuit switch. By the bowl-shaped groove arrangement, it is possible to overcome the problem of large deformation force caused by simply extending the length of the triggering portion and the conduction point FP is advanced. Thus, the conduction efficiency, i.e., the conduction agility at the time of pressing is improved, and the conduction performance for corner pressing is also improved, so that the key reaction is more agile.

### TECHNICAL FIELD

The present disclosure relates to the technical field of keyboards, and in particular to a rubber dome with advanced conduction.

### BACKGROUND

As shown in FIG. 1, the conventional thin film keyboard for notebook computers mainly includes a keycap 30, an X-type bracket 40 disposed under the keycap 30 for fixing and stabilizing the keycap 30, and a rubber dome 20, and a thin film circuit switch 10 is also disposed at the bottom.

Referring to FIG. 2, the rubber dome 20 of the conventional structure of the above thin film keyboard has an inverted bowl shape, which mainly includes a support portion 21, an elastic connection portion 22 and a pressing portion 23, and the pressing portion 23 has a protruding triggering portion 231 at an axially inner side thereof, and the support portion 21 of the mouth of the bowl is installed on the thin film circuit switch 10 for supporting, and the pressing portion 23 of the bottom of the bowl is used for contacting the keycap 30. When the keycap 30 is pressed, an axially outer end of the pressing portion 23 of the rubber dome 20 first contacts the keycap 30 and is driven by the keycap 30 and is triggered downward along the axis, further, the triggering portion 231 at the axially inner end of the pressing portion 23 presses the thin film circuit switch 10 at the inner side to drive electrode contact points 11 in the thin film circuit switch 10 to contact each other to realize conduction, and is reset by the elastic connection portion 22 of the rubber dome 20 after the pressing is canceled, and then the pressing portion 23 is reset and the keycap 30 is driven to reset.

Since the above-mentioned rubber dome 20 in the prior art is integrally injection-molded using the rubber material, when the rubber dome 20 is pressed, and the triggering portion 231 at the axially inner end of the pressing portion 23 presses the thin film circuit switch 10 at the inner side to drive the electrode contact points 11 in the thin film circuit switch 10 to contact each other for conduction, a conduction point FP will generally fall after F2 shown in FIG. 3, the reason is because the triggering portion 231 at the axially inner end of the pressing portion 23 is too far from the surface of the thin film circuit switch 10 (the axial end of the triggering portion 231 is spaced at a distance a from the surface of the thin film circuit switch 10, the axial upper surface of the support portion 21 is spaced at a distance h from the surface of the thin film circuit switch 10, and a>h), it is necessary to press the triggering portion 231 for a long distance to hit the thin film circuit switch 10. The longer the pressing distance, the greater the deformation of the rubber dome 20. The too much deformation of the rubber dome 20 causes the conduction delay or the inability to conduct, and particularly, the corner conduction failure is more likely to occur when the corner conduction performance is tested.

In order to solve the above problems and improve the conduction property, the conventional manner is a manner of reducing the triggering force of the thin film circuit switch 10, but if the conduction property is improved simply by reducing the triggering force of the thin film circuit switch 10, it is easy to cause an over-sensitivity phenomenon.

### SUMMARY

To solve the above technical problem, the present disclosure provides a rubber dome with advanced conduction, including a support portion, an elastic connection portion, and a pressing portion connected in sequence, the pressing portion having a columnar triggering portion at an axially inner side thereof, wherein an axial end of the triggering portion is spaced at an axial distance b from an axially lower surface of the support portion, an axial upper surface of the support portion is spaced at a distance h from the axially lower surface of the support portion, and b<h; and
the pressing portion is axially opened with a bowl-shaped groove extending to the triggering portion.

The support portion, the elastic connection portion, the pressing portion and the triggering portion are integrally formed using a rubber material.

The support portion is further provided with an exhaust groove penetrating inside and outside.

The present disclosure further provides a keyboard structure, including a thin film circuit switch, a rubber dome fitted on an upper surface of the thin film circuit switch, a keycap arranged on an upper end surface of the rubber dome, and an X-type bracket arranged under the keycap; wherein the rubber dome is a rubber dome with advanced conduction of the above structure.

With the above technical solution, the rubber dome with the triggering portion of an extended length provided by the present disclosure avoids the over-sensitivity phenomenon conventionally caused by lowering the triggering force of the thin film circuit switch by adjusting the conduction distance b to make the triggering portion closer to the thin film circuit switch, and the conduction distance b is reduced with respect to the prior art. By the bowl-shaped groove arrangement, it is possible to overcome the problem of the large deformation force caused by simply extending the length of the triggering portion, and when the triggering portion contacts the thin film circuit switch, the force generated is the force of the side wall of the triggering portion and the force of the triggering portion to the bowl-shaped groove, and when the descending force of the side wall of the triggering portion is less than the force of the triggering portion to the bowl-shaped groove, the conduction point FP is advanced. Thus, the conduction efficiency, i.e., the conduction agility at the time of pressing is improved, and the conduction performance for corner pressing is also improved, so that the key reaction is more agile. In addition, since the hollow triggering portion is relatively long and has good deformability, the hand feeling can be more excellent when pressing without affecting Click.

### BRIEF DESCRIPTION OF FIGURES

In order to more clearly illustrate the technical solutions in the embodiments of the present disclosure or the prior art, the accompanying drawings which are required to be used in the description of the embodiments or the prior art will be briefly described below.

FIG. 1 is a schematic axial cross-sectional diagram of a keyboard structure in the prior art;

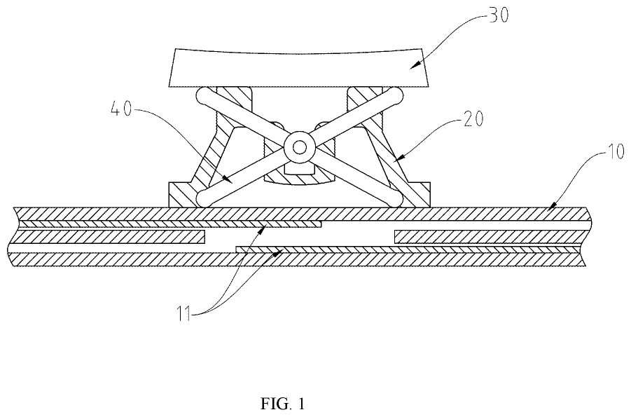

FIG. 2 is a schematic diagram of an axial cross-sectional structure of a rubber dome of the prior structure in FIG. 1;

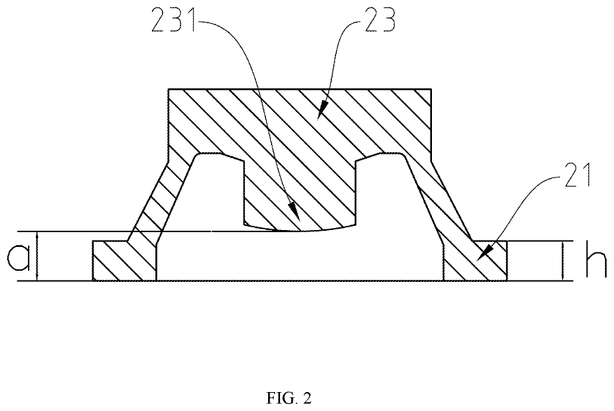

FIG. 3 is a diagram showing the pressing force and stroke of the rubber dome of the prior structure in FIG. 1;

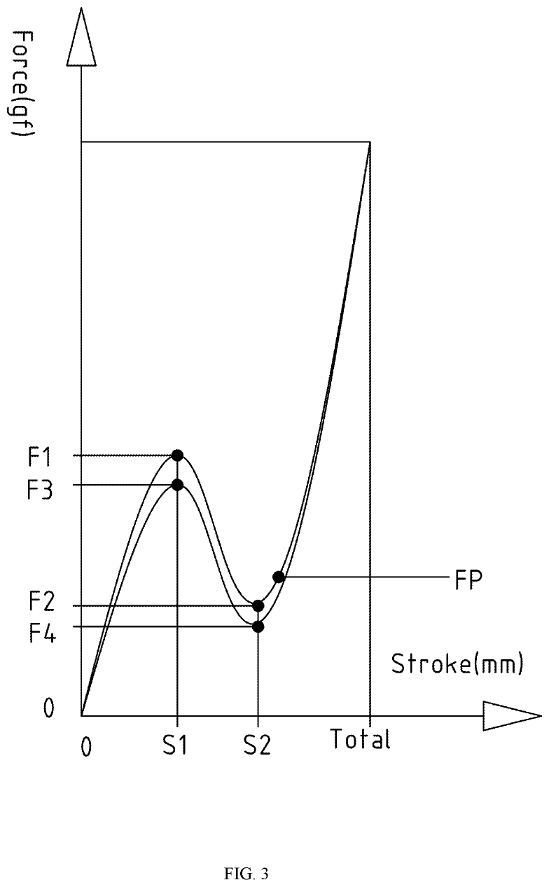

FIG. 4 is a schematic diagram of an axial cross-sectional structure of the rubber dome disclosed by the present disclosure;

FIG. 5 is a schematic axial cross-sectional diagram of the keyboard structure having the rubber dome of the structure in FIG. 4; and

FIG. 6 is a diagram showing the pressing force and stroke of the rubber dome of the structure in FIG. 4.

The numbers in the figures represent: 10. thin film circuit switch; 11. electrode contact point; 20. rubber dome; 21. support portion; 22. elastic connection portion; 23. pressing portion; 231. triggering portion; 232. bowl-shaped groove; 30. keycap; 40. X-type bracket.

### DETAILED DESCRIPTION

The following detailed description of the preferred embodiments of the present disclosure will be made with reference to the accompanying drawings so that the advantages and features of the present disclosure can be more readily understood by those skilled in the art, and thus the scope of the present disclosure will be more clearly defined.

### Embodiment 1

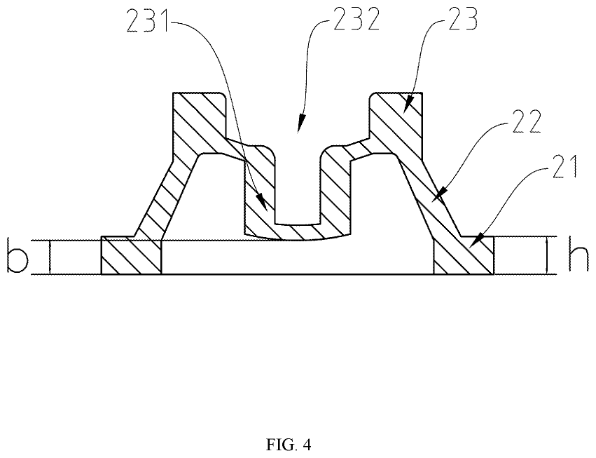

Referring to FIG. 4, Embodiment 1 provides a rubber dome with advanced conduction, the rubber dome includes a support portion 21, an elastic connection portion 22 and a pressing portion 23 integrally formed with a rubber material, the pressing portion 23 has a columnar triggering portion 231 at an axially inner side thereof, and the support portion 21 is further provided with an exhaust groove penetrating inside and outside;
an axial end of the triggering portion 231 is spaced at an axial distance b from an axially lower surface of the support portion 21, an axial upper surface of the support portion 21 is spaced at a distance h from the axially lower surface of the support portion 21, and b<h; and
the pressing portion 23 is axially opened with a bowl-shaped groove 232 extending to the triggering portion 231.

### Embodiment 2

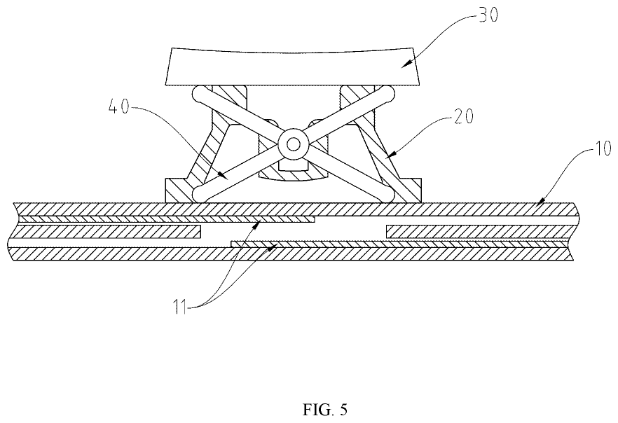

Referring to FIG. 5, Embodiment 2 provides a keyboard structure, the keyboard structure includes a thin film circuit switch 10, a rubber dome 20 fitted on an upper surface of the thin film circuit switch 10, a keycap 30 arranged on an upper end surface of the rubber dome 20, and an X-type bracket 40 arranged under the keycap 30; and
the rubber dome 20 is a rubber dome with advanced conduction in Embodiment 1.

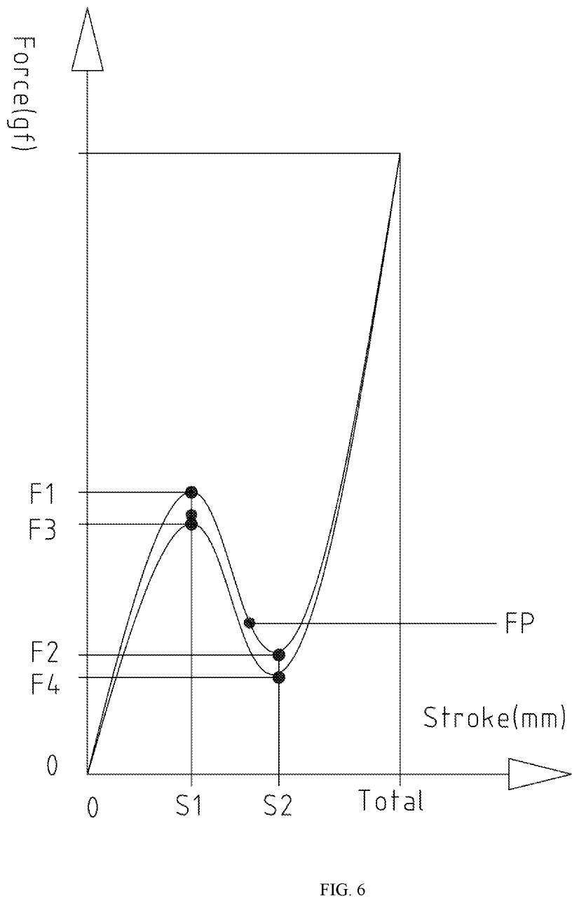

The rubber dome 20 with the triggering portion 231 of an extended length provided by Embodiment 2 avoids the over-sensitivity phenomenon conventionally caused by lowering the triggering force of the thin film circuit switch 10 by adjusting the conduction distance b to make the triggering portion 231 closer to the thin film circuit switch 10. By the bowl-shaped groove arrangement, it is possible to overcome the problem of large deformation force caused by simply extending the length of the triggering portion 231, and when the triggering portion 231 contacts the thin film circuit switch 10, the force generated is the force of the side wall of the triggering portion 231 and the force of the triggering portion 231 to the bowl-shaped groove 232, and the descending force of the side wall of the triggering portion 231 is less than the force of the triggering portion 231 to the bowl-shaped groove 232, the conduction point FP will be generated before F2 shown in FIG. 6. Thus, the conduction efficiency, i.e., the conduction agility at the time of pressing is improved, and the conduction performance for corner pressing is also improved, so that the key reaction is more agile. In addition, since the hollow triggering portion 231 is relatively long and has good deformability, the hand feeling can be more excellent when pressing without affecting Click.

The previous description of the disclosed embodiments is provided to enable those skilled in the art to make or use the present disclosure. Various modifications to the above-described embodiments will be readily apparent to those skilled in the art, and the generic principles defined herein may be implemented in other embodiments without departing from the spirit or scope of the disclosure. Thus, the present disclosure is not intended to be limited to the embodiments shown herein but conforms to the widest scope consistent with the principles and novel features disclosed herein.

1. A rubber dome with advanced conduction, comprising a support portion (21), an elastic connection portion (22), and a pressing portion (23) connected in sequence, the pressing portion (23) having a columnar triggering portion (231) at an axially inner side thereof, wherein
an axial end of the triggering portion (231) is spaced at an axial distance b from an axially lower surface of the support portion (21), an axial upper surface of the support portion (21) is spaced at a distance h from the axially lower surface of the support portion (21), and b<h; and
the pressing portion (23) is axially opened with a bowl-shaped groove (232) extending to the triggering portion (231).

2. The rubber dome with advanced conduction according to claim 1, wherein the support portion (21), the elastic connection portion (22), the pressing portion (23) and the triggering portion (231) are integrally formed using a rubber material.

3. The rubber dome with advanced conduction according to claim 1, wherein the support portion (21) is further provided with an exhaust groove penetrating inside and outside.

4. A keyboard structure, comprising a thin film circuit switch (10), a rubber dome (20) fitted on an upper surface of the thin film circuit switch (10), a keycap (30) arranged on an upper end surface of the rubber dome (20), and an X-type bracket (40) arranged under the keycap (30);
wherein the rubber dome (20) is the rubber dome with advanced conduction according to claim 1.
